(19) United States
(12) Patent Application Publication
(10) Pub. No.: US 2006/0255562 A1
(43) Pub. Date: Nov. 16, 2006

(54) Anti-wobble device for receiver-type trailer hitch

(76) Inventor: Raymond Lantaigne, New-Liskeard (CA)

Correspondence Address: GREENBLUM & BERNSTEIN, P.L.C., 1950 ROLAND CLARKE PLACE, RESTON, VA, 20191, US

(21) Appl. No.: 11/127,181

(22) Filed: May 12, 2005

(51) Int. Cl. B60D 1/04

(52) U.S. Cl. 280/506

(57) ABSTRACT

An anti-wobble receiver-type trailer hitch device comprising a receiver tube having an open end; a mount slidably insertable into and removable from the open end of the receiver tube, the mount having a leading end for leading it into the receiver tube; an elongated embosser on at least one of said receiver tube and mount and parallel to its longitudinal axis; and an elongated channel in the other of said receiver tube and mount, parallel to its longitudinal axis, and adapted to snugly engage said embosser for locking the receiver tube and mount against wobbling movement.

### CROSS-REFERENCE TO RELATED APPLICATIONS

Not applicable

### STATEMENT REGARDING FEDERALLY SPONSORED RESEARCH OR DEVELOPMENT

Not applicable.

### REFERENCE TO A “SEQUENCE LISTING”

Not applicable.

### FIELD OF INVENTION

The invention relates to receiver-type trailer hitches, and more specifically to a device for eliminating rattling due to movement of connecting parts in the hitch.

### BACKGROUND OF THE INVENTION

In receiver-type hitches, in order to avoid seizing of the mount inside the receiver tube, the mount and receiver tube are adapted to engage each other loosely—the receiver tube is made wider or the mount is made narrower. Due to the receiver tube receiving the mount non-frictionly, there will consequently result a wobbling movement between the mount and the receiver tube causing vibrations and rattling noises.

Various devices and methods have been invented to deal with this problem. Known prior art includes U.S. Pat. No. 6,382,656 issued May 7, 2002, to Johnson, Jr.; U.S. Pat. No. 6,105,989 issued Aug. 22, 2000, to Linger; U.S. Pat. No. 5,988,667 issued Nov. 23, 1999, to Young; U.S. Pat. No. 6,010,143 issued Jan. 4, 2000, to Stein; U.S. Pat. No. 6,131,938 issued Oct. 17, 2000, to Speer; and U.S. Pat. No. 5,735,539 issued Apr. 7, 1998, to Kravitz.

Although these devices and methods inhibit wobble movement of the mount inside the receiver tube, they all require a considerable amount of skill and effort, and they are all time consuming. Therefore, there is a need for an easy-to-use, quick-to-install, anti-wobble receiver-type trailer hitch device.

### SUMMARY OF THE INVENTION

In response to this need, the present invention provides an anti-wobble receiver-type trailer hitch device comprising a receiver tube having an open end; a mount slidably insertable into and removable from the open end of the receiver tube, the mount having a leading end for leading it into the receiver tube; an elongated embosser on at least one of said receiver tube and mount and parallel to its longitudinal axis, and an elongated channel in the other of said receiver tube and mount, parallel to its longitudinal axis, and adapted to snugly engage said embosser for locking the receiver tube and mount against wobbling movement.

The present invention further provides an anti-wobble arrangement for use with a receiver-type trailer hitch having a receiver tube having an open end, and a mount slidably insertable into and removable from the open end of the receiver tube, comprising: an elongated embosser on at least one of said receiver tube and mount and parallel to its longitudinal axis; and an elongated channel in the other of said receiver tube and mount, parallel to its longitudinal axis, and adapted to snugly engage said embosser for locking the receiver tube and mount against wobbling movement.

The present invention also provides the advantage of inhibiting wobbling movement of the mount inside the receiving tube without requiring much effort or time to install. Other advantages will suggest themselves to those skilled in the art.

### BRIEF DESCRIPTION OF THE DRAWINGS

The invention, its organization, construction and operation will be best understood by reference to the following detailed description taken into conjunction with the accompanying drawings, in which:

FIG. 1 is a perspective view of a preferred embodiment of the present invention.

FIG. 2 shows an alternative embodiment of the present invention.

### DETAILED DESCRIPTION OF THE PREFERRED EMBODIMENT

The following description shows only preferred embodiments of the present invention. Various modifications are apparent to those skilled in the art without departing from the scope of the present invention, which is only limited by the appended claims. Therefore, the embodiments shown and described are only illustrative, not restrictive.

Also, throughout the following description, specific details are set forth in order to provide a more thorough understanding of the invention; the invention, however, may be practiced without these particulars. In other instances, well-known elements have not been shown or described in detail to avoid unnecessarily obscuring of the invention.

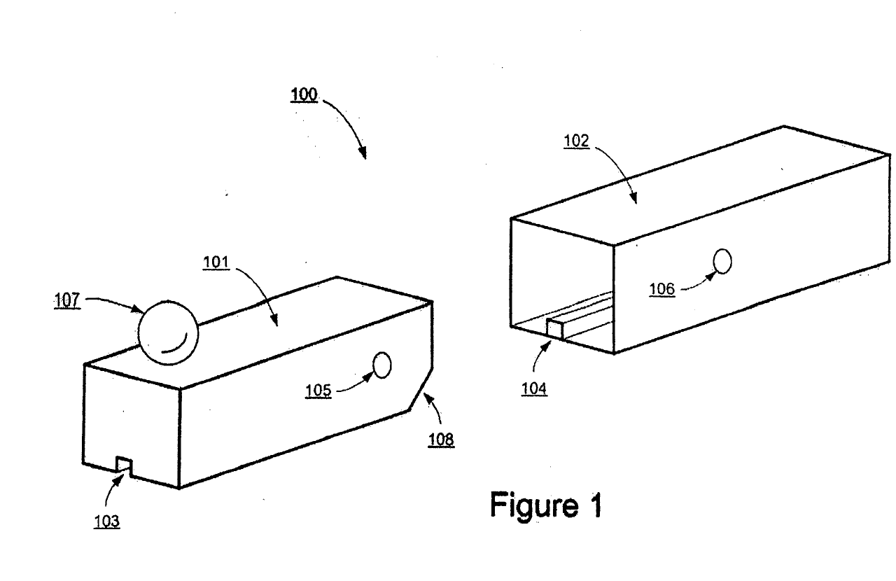

Referring to FIG. 1, there is illustrated in a perspective view, an anti-wobble receiver-type trailer hitch device (generally indicated by reference numeral 100) in accordance with the preferred embodiment of the present invention. The hitch device includes a receiver tube 102, which is usually attached to the towing vehicle, and a mount 101. The mount 101 telescopes with (and, specifically, inserts into) the receiver tube 102, which is hollow.

When the mount 101 is fully telescoped to the receiver tube 102, a conventional cross pin (not shown) is inserted through the holes 106, 105 to hold the components 102 and 101 together. The mount 101 may have a cut-off corner 108 to facilitate its insertion into the receiver tube 102.

To prevent the seizing of the mount 101 inside the receiver tube 102, the components (101, 102) are adapted to telescope loosely, resulting in the wobbling of the mount 101 inside the receiver tube 102. In the present invention, to inhibit such wobbling, the bottom wall of the receiver tube 102 comprises an elongated embosser (tongue) 104 along its longitudinal axis, while the bottom wall of the mount 101 comprises an elongated groove (channel) 103 along its longitudinal axis. The embosser 104 and groove 103 are adapted so that when the mount 101 is inserted into the receiver tube 102, the embosser 104 snugly receives groove 103 locking the mount 101 against wobbling movement inside the receiver tube 102.

A conventional trailer ball 107 is attached to the other end of the mount 101—the non-inserted end. While the preferred embodiment of the instant invention is described in reference to a ball mount 101, it can be used without adaptation or with modification in conjunction with a variety of adapted mounts—mounts comprising a channel (or an embosser, as explained below)—insertable and removable into and from the receiver tube 102, such as hitch mountable bicycle carriers, ski carriers, utility shelf carriers, truck ramps, truck-bed extensions, and other devices mountable to a receiver tube 102 of a receiver-type trailer hitch.

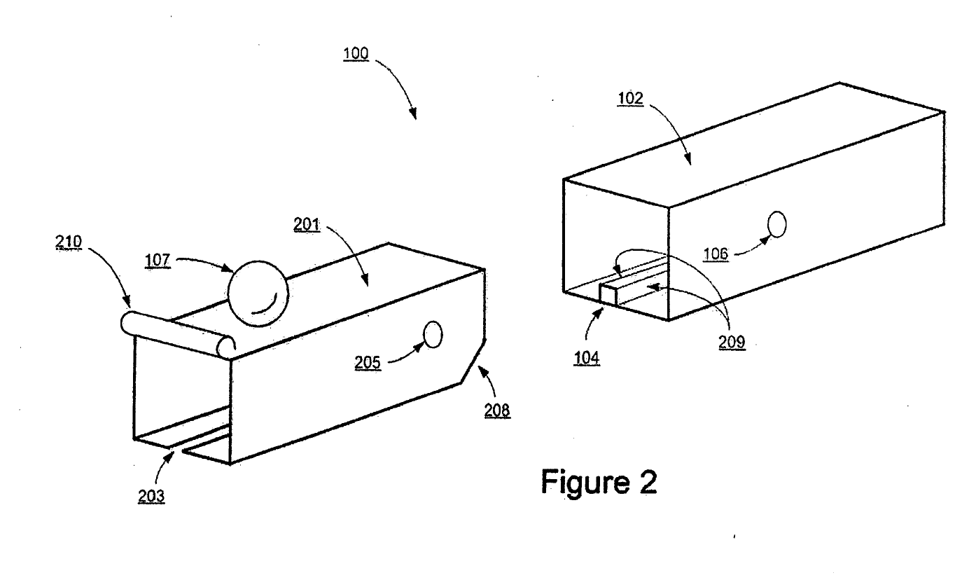

In this document, the embosser 104 and groove 103 were illustrated as being formed along the bottom walls of the receiver tube 102 and mount 101, respectively. This should be regarded as a preference, rather than a restriction. Also, FIGS. 1 and 2 show the embosser 104 and groove 103 along the middle of the aforementioned walls. This, too, is not a restriction. Furthermore, the invention would also work by having the embosser formed on the mount, and the groove formed in the receiver tube.

The alternative embodiments discussed in the preceding paragraph are not shown. However, FIG. 2 shows yet another embodiment of the present invention. (Like parts have been given the same reference numerals.) In this embodiment, the mount 201 is hollow (a sleeve) and the elongated channel is in the form of a slot 203 formed along its bottom wall. Due to the thickness of the sleeve (not shown), the slot 203 has vertical walls (not shown), which snugly engage the vertical walls 209 of the embosser 104 of the receiver tube 102 to inhibit any wobbling of the components 102, 201.

A portion of the top wall of the sleeve mount 201 can be curled to form a handle-like member 210 to be utilized in pulling the mount 201 out of the receiver tube 102. Of course, the invention can be used with or without a handle—curled or otherwise. For example, in the case of a ball mount, one could use the trailer ball 107 to pull the mount 201, 101 out of the receiver tube 102.

Other embodiments and uses of the invention will be apparent to those skilled in the art from consideration of the specification and practice of the invention disclosed herein. The specification and examples should be considered exemplary only and do not limit the intended scope of the invention.

I claim:

1. An anti-wobble receiver-type trailer hitch device comprising:
a receiver tube having an open end;
a mount slidably insertable into and removable from the open end of the receiver tube, the mount having a leading end for leading it into the receiver tube;
an elongated embosser on at least one of said receiver tube and mount and parallel to its longitudinal axis; and
an elongated channel on the other of said receiver tube and mount, parallel to its longitudinal axis, and adapted to snugly engage said embosser for locking the receiver tube and mount against wobbling movement.

2. The device of claim 1, wherein the receiver tube and the mount are square shaped for use with a square hitch.

3. The device of claim 1, wherein the leading end of the mount is narrower than the mount for facilitating the insertion of the mount into the receiver tube.

4. The device of claim 1, wherein the mount comprises a handle for pulling the mount out of the receiver tube.

5. The device of claim 4, wherein the handle is achieved by curling a projection part of a wall of the mount.

6. The device of claim 5, wherein the wall is a top wall.

7. The device of claim 1, wherein the mount is a sleeve.

8. An anti-wobble arrangement for use with a receiver-type trailer hitch having a receiver tube having an open end, and a mount slidably insertable into and removable from the open end of the receiver tube, comprising:
an elongated embosser on at least one of said receiver tube and mount and parallel to its longitudinal axis; and
an elongated channel in the other of said receiver tube and mount, parallel to its longitudinal axis, and adapted to snugly engage said embosser for locking the receiver tube and mount against wobbling movement.
